(19) United States
(12) Patent Application Publication
(10) Pub. No.: US 2011/0308224 A1
(43) Pub. Date: Dec. 22, 2011

(54) Finger bar

(76) Inventors: Dominik Buermann, Verl (DE); Stefan Liedmeier, Ibbenbueren (DE)

(21) Appl. No.: 13/163,896

(22) Filed: Jun. 20, 2011

(30) Foreign Application Priority Data
Jun. 22, 2010 (DE) 10 2010 017 502.1

(51) Int. Cl. A01D 34/14

(52) U.S. Cl. 56/296

(57) ABSTRACT

A finger bar for a header has a knife bar with at least two partial rails which are interconnectable at the end faces thereof, and a cutting system which can move back and forth in an oscillating manner, is attachable to the knife bar, and is deflectable transversely to the longitudinal axis thereof, in the vertical direction, and the partial rails are interconnectable in a form-locking manner on the end faces thereof that face each other.

### CROSS-REFERENCE TO RELATED APPLICATION

The invention described and claimed hereinbelow is also described in German Patent Application DE 10 2010 017 502.1 filed on Jun. 22, 2010. This German Patent Application, whose subject matter is incorporated here by reference, provides the basis for a claim of priority of invention under 35 U.S.C. 119(a)-(d).

### BACKGROUND OF THE INVENTION

The present invention relates to a finger bar.

Finger bars for a header comprise a knife bar onto which a cutting system can be attached, said cutting system being movable back and forth in an oscillating manner transversely to the direction of travel of a self-propelled harvesting machine. The cutting system comprises a rail to which knives are attached and is movable in a reciprocating manner by a drive, and comprises a knife bar to which knife guards are attached; said knife guards guide the knives and function as counter-blades. To compensate for ground contours, the cutting system can be deflected transversely to the longitudinal direction thereof, in the vertical direction, which is achieved via a flexible design of the cutter bar. The knife bar, which extends transversely to the direction of travel, comprises at least two partial rails which are interconnectable at the end faces thereof that face one another, and are aligned axially.

Such a finger bar is known from EP 2 022 313 B1. The finger bar described in EP 2 022 313 B1 comprises a first and a second cutter bar which are in the form of two axially aligned partial rails, the end faces of which are adjoined, and to which knife guards are attached. Reciprocating bars to which knives are attached are disposed on the partial rails, parallel thereto; said bars are likewise aligned with each other. The bars overlap in sections on the ends thereof that face each other, thereby forming a region between the attached knives in which the knives overlap. A coupling device is attached to the cutter bar and the reciprocating bars to restrict the motion of the cutter bar and the reciprocating bars upon vertical deflection thereof to a single linear direction. The coupling device is configured such that the cutter bars remain in a coaxial position in the region of the coupling device, while the reciprocating bars are held in a coplanar position. Such a coupling device has a very complex design, however.

### SUMMARY OF THE INVENTION

The problem addressed by the present invention is that of providing a cutter bar of the initially stated type, the partial rails—which form the knife bar—of which can be interconnected in a relatively simple structural manner such that the partial rails are held securely in a coaxial position in the connecting region thereof when tensile forces occur, said tensile forces being produced by a deflection of the cutting system in the vertical direction.

According to the invention, the partial rails of the knife bar are interconnected in a form-locking manner on the end faces thereof. The tensile forces produced by a vertical deflection of the cutting system are absorbed by the form-locking connection such that the ends of the partial rails do not bend apart or rotate relative to one another, which would undo the coaxiality of the knife bar. Furthermore, the form-locking connection ensures that the partial rails remain aligned in the longitudinal direction thereof, which is essential for ensuring reliable interplay of the knives, which are attached to the partial rails via the reciprocating rails, and the knife guards which are disposed on the partial rails and are in the form of counter-blades. Since the knife bar functions as a carrier of the cutting system, the partial rails must point toward one another in the installed state, which is attained via the form-locking connection of the partial rails.

Displacement in the finger bar, which would interfere with the unimpeded movement of the oscillating cutting system, is thereby prevented. Moreover, form-locking connections make it possible to easily connect two or more partial rails to form a knife bar in order to fulfill the increasing requirements for greater cutting width. The form-locking connection also makes it possible to easily replace a single partial rail if this should become necessary. Due to the form-locking connection and the related simplicity of assembly, the knife bar can be advantageously composed of a plurality of partial rails, each of which is less than approximately three meters in length. Connecting partial rails having said length is advantageous in terms of processes within an organization, since the handling thereof is simplified. The same applies for the shipment of partial rails as replacement parts, since it is easier to ship partial rails having a limited length.

Preferably, the partial rails can comprise, on the end faces thereof, a projection or a recess which corresponds to the contour of the projection, wherein the projection and the recess have supplementary undercuts which form abutments. The abutments formed by the supplementary undercuts help to retain the form-locking connection, thereby preventing separation via bending—in particular in the region of the recess enclosing the projection—which would be caused by the tensile forces to be transferred when vertical deflection occurs.

In particular, the undercuts can be designed to taper in the longitudinal direction of the partial rails.

The undercuts, which face each other, can have angles of inclination which are supplementary and form an angle of 180°.

The projection can be designed substantially in the shape of a “T”.

In a preferred development, the undercuts, which face each other, can comprise curvatures which are supplementary and form an angle of 180°.

The projection can be designed substantially in the shape of a mushroom.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAVVING

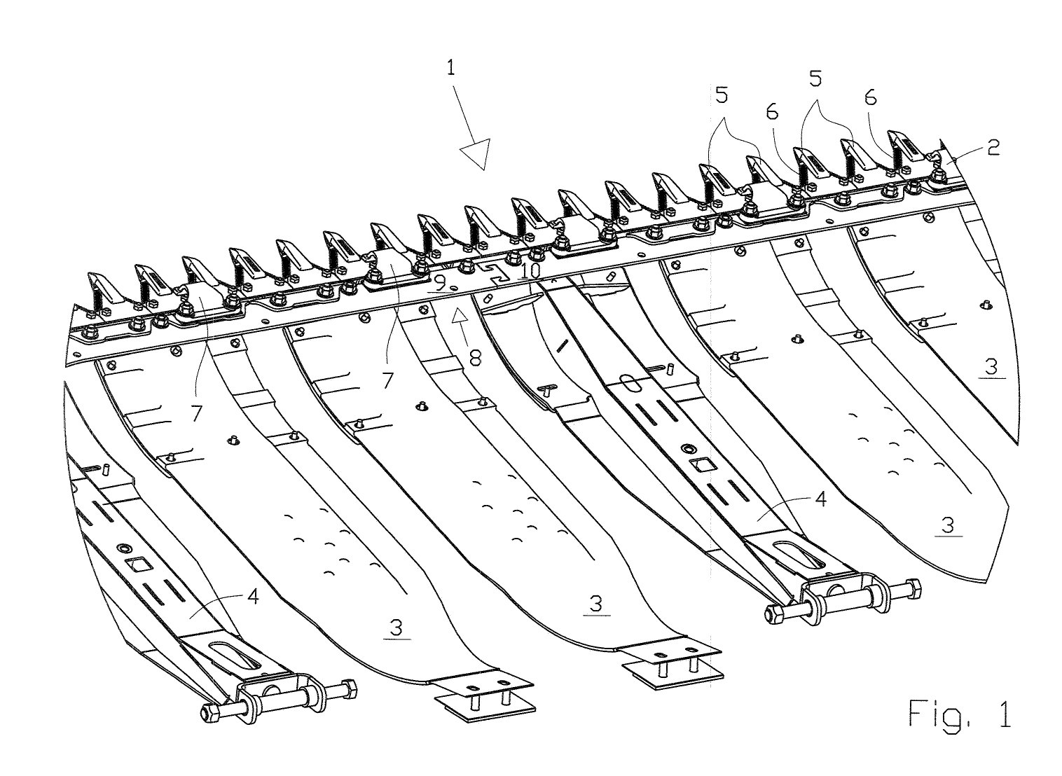

FIG. 1 shows a detailed view of a header comprising a flexible cutter bar in accordance with the present invention;

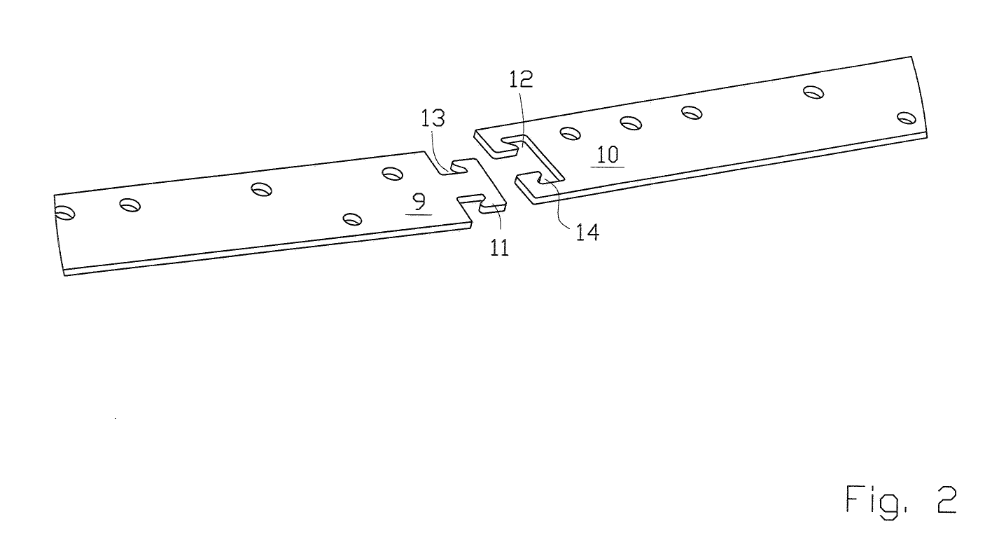

FIG. 2 shows a perspective partial view of two interconnectable end sections of partial rails of a knife bar of FIG. 1 in accordance with the present invention.

### DESCRIPTION OF THE PREFERRED EMBODIMENTS

To cut the crop, a header which is known per se and is shown in a detailed view in FIG. 1 is disposed on the front side of a combine harvester which is not shown in the drawing. The header mainly comprises a device for conveying cut crop, a flexible cutter bar 1 on which a cutting system 2 is disposed, and a large number of adjacently disposed undercarriage skids 3. Undercarriage skids 3 are composed of an inherently resilient plastic having a smooth surface and good gliding properties. In addition, profiled base carriers 4 which extend approximately horizontally and are interspaced are provided on the header. The front ends of undercarriage skids 3 are connected to cutter bar 1 via threaded connections. Cutting system 2 disposed on cutter bar 1 comprises knives 6 which are disposed on a reciprocating rail, and knife guards 5 in the form of counter-blades.

Cutting system 2 is connected to the header via a knife bar 8. The header is suitable for harvesting grain, beans, or other crops that grow low to the ground. To harvest grain, the header is guided at a distance above the field, and cutter bar 1 cuts the stalks in a straight plane; to harvest beans, the header is lowered to the point at which undercarriage skids 4 have contact with the ground across the entire width of the header, and flexible cutter bar 1 adapts to the continuously changing ground profile in an elastically resilient manner transversely to the direction of travel, thereby ensuring that the cutting height is optimal and as low as possible in all regions of cutter bar 1.

Knife bar 8 is designed as a multiple-component flat profile and comprises at least two partial rails 9, 10 which are disposed on the header in axial alignment with each other. To this end, the at least two partial rails 9, 10 are interconnectable in a form-locking manner on their abutting end faces. To facilitate a form-locking connection, partial rails 9, 10 comprise on the end faces thereof a projection 11 and a recess 12 which corresponds to the contour of projection 11, wherein projection 11 and recess 12 can comprise supplementary undercuts 13, 14 which form abutments. As a result, the tensile forces caused by the vertical deflection of flexible cutter bar 1 as it follows a continuously changing ground profile and which act on partial rails 9, 10 do not cause the form-locking interconnected ends of the partial rails to bend apart, but rather cause same to draw together and thereby undergo self-stabilization and orientation relative to each other.

In particular, undercuts 13, 14 taper toward the end face of particular partial rail 9, 10, thereby enabling projection 11 and recess 12 to interlock in the installed state and form an abutment. Projection 11 of a partial rail 9 is preferably designed substantially in the shape of a “T”, and therefore undercuts 13, 14—which face each other—of projection 9 and recess 10 corresponding to the contour of projection 9 have angles of inclination that are supplementary and form an angle of 180°.

Alternatively, undercuts 13, 14 which face each other have curvatures that are supplementary and form an angle of 180°, wherein projection 9 is designed substantially in the shape of a mushroom.

To connect more than two partial rails to form a knife bar 8, one or more central partial rails disposed between partial rails on the ends are designed with a projection on the end face of one end, and with a recess in the opposite end. The length of knife bar 8 can thereby be designed in a flexible manner, and can be easily adapted to various header widths.

It will be understood that each of the elements described above, or two or more together, may also find a useful application in other types of constructions differing from the types described above.

While the invention has been illustrated and described as embodied in a finger bar, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A finger bar for a header, comprising a knife bar having at least two partial rails which are interconnected at their end faces; and a cutting system movable back and forth in an oscillating manner, wherein the cutting system is attachable to said knife bar and deflectable transversely to a longitudinal axis of said knife bar in a vertical direction, and wherein the partial rails are interconnected in a form-locking manner on the end faces that face each other;

2. A finger bar as defined in claim 1, wherein the partial rails on the end faces have correspondingly a projection and also a recess which corresponds to a contour of the projection, wherein the projection and the recess have supplementary undercuts which form abutments.

3. A finger bar as defined in claim 2, wherein the undercuts taper in a longitudinal direction of the partial rails.

4. A finger bar as defined in claim 2, wherein the undercuts which face each other have angles of inclination that are supplementary and form an angle of 180°.

5. A finger bar as defined in claim 2, wherein the projection is substantially T-shaped.

6. A finger bar as defined in claim 2, wherein the undercuts which face each other have curvatures that are supplementary and form an angle of 180°.

7. A finger bar as defined in claim 2, wherein the projection is substantially mushroom-shaped.
